(19) United States
(12) Patent Application Publication
(10) Pub. No.: US 2014/0100988 A1
(43) Pub. Date: Apr. 10, 2014

(54) On-Line Garage Sale

(71) Applicant: Joseph A. Marx, Sinking Spring, PA (US)

(72) Inventor: Joseph A. Marx, Sinking Spring, PA (US)

(73) Assignee: eBay Inc., SAN JOSE, CA (US)

(21) Appl. No.: 13/647,141

(22) Filed: Oct. 8, 2012

(51) Int. Cl. G06Q 30/00; G06Q 30/06

(52) U.S. Cl. 705/26.61; 705/26.1; 705/26.8; 705/26.9

(57) ABSTRACT

One example embodiment relates to a method that comprises receiving from a first user, via a network, a listing of one or more items that are part of a garage sale. The method includes storing the item listing in a database and presenting, using at least one processor and via the network, at least part of the item listing to a second user connected to the network. The method also includes providing data to the second user indicating a geographic region or location at which the garage sale is located.

### FIELD

This application relates generally to garage sales, and more specifically to systems and methods for on-line listings of items in a garage sale. The application also relates generally to the creation and presentation of garage sale listings using a portable electronic device.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012, EBAY, INC., all Rights Reserved.

### BACKGROUND

Garage sales are a common way for people to buy and sell goods. Most garage sales are conducted by placing signs in the neighborhood where the garage (i.e., rummage) sale is being held. Some people also often advertise in the local newspaper or church bulletin as a way to increase attendance at their garage sale.

### SUMMARY

In an example embodiment, a system comprises at least one module, executing on one or more computer processors, to receive from a first user, via a network, a listing of one or more items that are part of a garage sale; store the item listing in a database; present, via the network, at least part of the item listing to a second user connected to the network; and provide data to the second user indicating a geographic region or location at which the garage sale is located.

In another example embodiment, machine readable medium includes instructions, which when performed by a machine, causes the machine to perform the operations of receiving from a first user, via a network, a listing of one or more items that are part of a garage sale; storing the item listing in a database; presenting, using at least one processor and via the network, at least part of the item listing to one or more second users connected to the network; and providing data to the second user indicating a geographic region or location at which the garage sale is located.

In another example embodiment, system comprises at least one module, executing on one or more computer processors to receive from a first user, via a network, a listing of one or more items that are part of a garage sale; store the item listing in a database; and include, via the network, at least part of the item listing in an electronic market place listing.

In another example embodiment, a machine readable medium includes instructions, which when performed by a machine, causes the machine to perform the operations of receiving from a first user, via a network, a listing of one or more items that are part of a garage sale; storing the item listing in a database; and including, using at least one processor and via the network, at least part of the item listing in an electronic market place listing.

### BRIEF DESCRIPTION OF DRAWINGS

Embodiments are illustrated by way of example and not limitation in the figures of the accompanying drawings. Like reference numbers indicate similar elements.

FIG. 1 is a block diagram illustrating an example embodiment of an architecture within which systems and methods for on-line marketplace listings of items in a garage sale may be executed.

FIG. 2 is a perspective view illustrating an example embodiment of a yard sign.

FIG. 3 is a perspective view illustrating an example embodiment of a brochure.

FIG. 4 is a block diagram illustrating an example embodiment of a system for on-line marketplace listings of items in a garage sale.

FIGS. 5A-5C are screenshots illustrating example marketplace listings of items in a garage sale displayed on an electronic device.

FIG. 6A-6B are flow charts illustrating example embodiments of methods for on-line listings of items in a garage sale.

FIG. 7 is a diagrammatic representation illustrating an example machine in the form of a computer system within which a set of instructions for causing the machine to perform a portion of any one or more of the methodologies discussed herein may be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

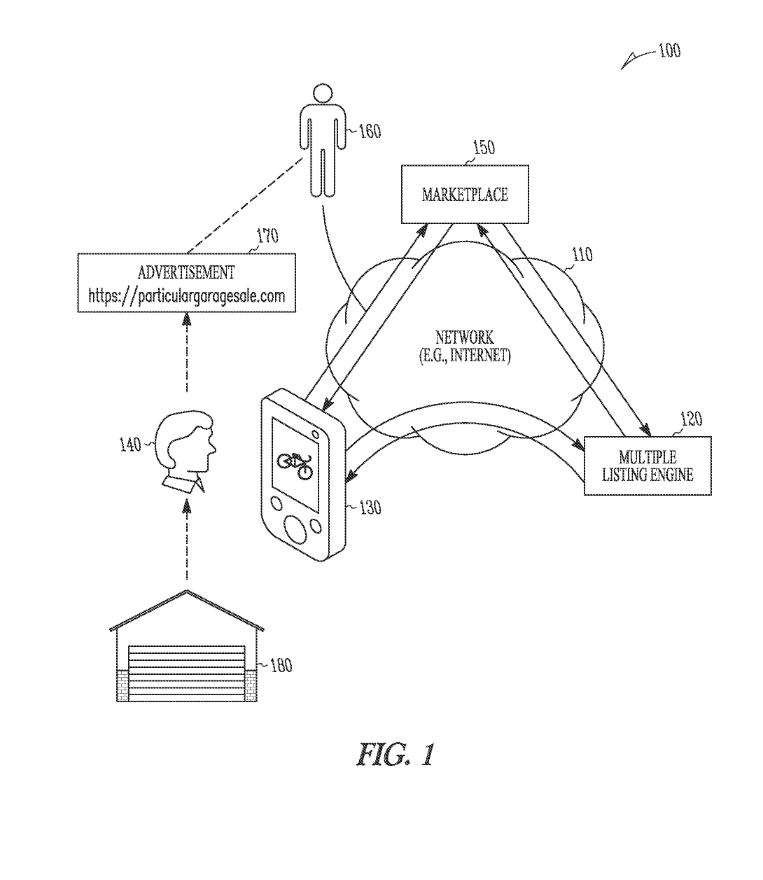

Some example embodiments of systems and methods for on-line marketplace listings of items in a garage sale are described herein. The systems and methods may serve to improve the experience of sellers conducting garage sales. The term “garage sale” in this specification is intended to include other temporary seller locations, such as a farmers' market, a tent or a show stall, for example. FIG. 1 illustrates an example environment 100 that may include a computer network 110, a multiple listing engine 120, an electronic device 130, a user 140, an electronic marketplace 150, buyers 160, an advertisement 170 and a garage sale 180. The network 110 may have multiple data processing nodes interconnected for the purpose of data communication. The electronic device 130 may include a desktop computer, laptop computer, mobile device (e.g., cell phone, PDA, global positioning system) or any other electronic device that is capable of interacting with the computer network 110. The electronic device 130 may include a Graphical User Interface (GUI) that can be manipulated by the user 140. The GUI may offer text menus or require typed commands. The GUI may also allow the input of gestures or other alternative input like voice or visual commands. In alternative forms, the electronic device 130 may be configured to utilize icons in conjunction with text, labels, voice commands or text navigation to represent the information and actions available to the user 140.

The user 140 may be a person interacting with the electronic device 130 via the GUI. A user 160 may also be a person interacting with a respective electronic device 130 via a GUI. An electronic device 130 can access, via the network 110, the electronic market place 150 and multiple listing engine 120 to view or create the items listings for a garage sale, as is explained in more detail below.

The electronic marketplace 150, in the context of the illustrated example network environment 100, may be an online auction and/or a fixed-price shopping website configured to permit individual users and businesses to buy and sell goods and services (e.g., eBay or Milo.com). The electronic marketplace 150 may be a part of worldwide electronic commerce, which includes buying and selling of products or services over electronic systems such as the Internet and other computer networks.

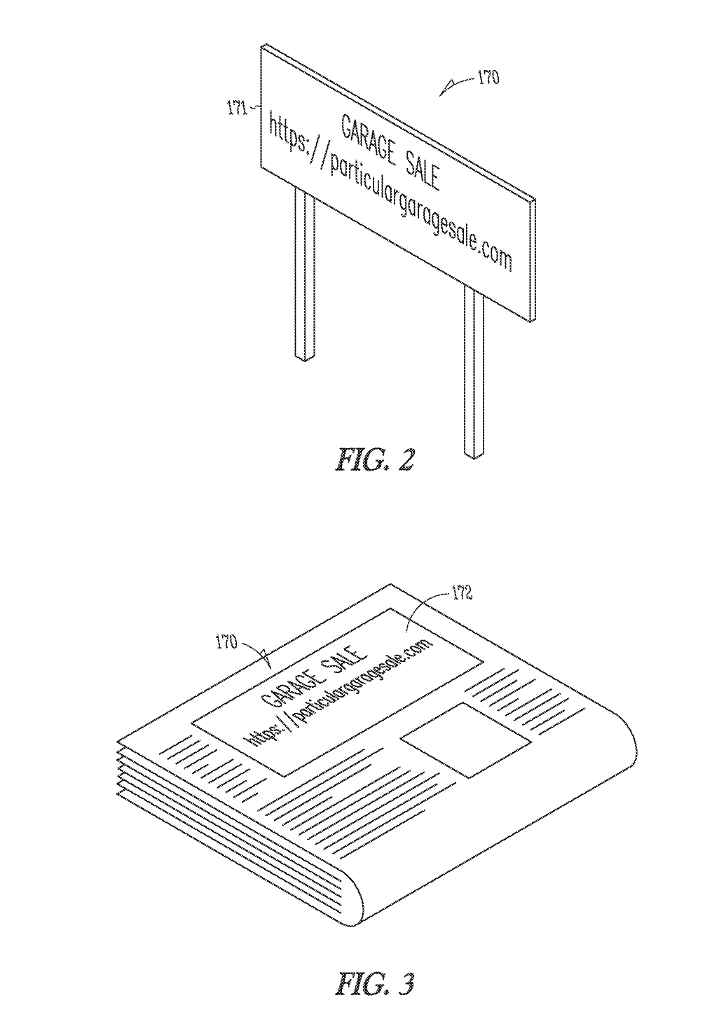

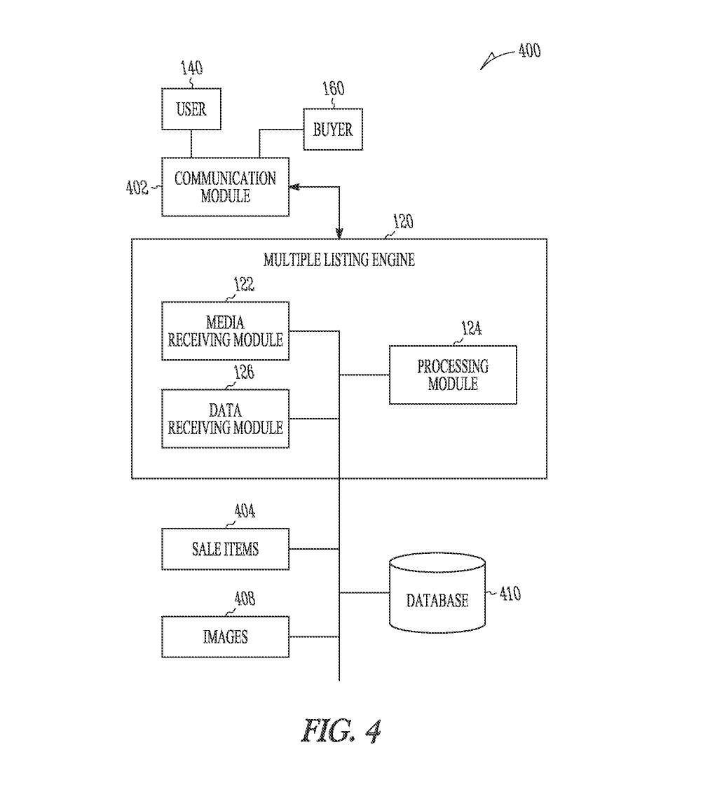

The advertisement 170 includes information as to where buyers 160 can view the items that are part of the garage sale 180 on the computer network 110. As examples, the advertisement 170 may be a yard sign (see FIG. 2), a brochure (see FIG. 3), a banner, or some other form of advertising that would provide information to the potential buyers that are near the garage sale 180. The particular information on the advertisement 170 that lets buyers 160 know where they can view the items that are part of the garage sale 180 on the computer network 110 may take the form of a web address (e.g., https://particulargaragesale.com). In some embodiments, the advertisements include online or virtual advertisements. Embodiments of the advertisements can include informational material and physical (e.g. yard sign) and on-line (e.g. website based) advertisements may be used in conjunction with each other as part of an overall marketing campaign. In some embodiments, advertisements featuring the garage sale are used in conjunction with marketing efforts or devices relating to more mainstream on-line commerce, such as eBay, craigslist.com, RedLaser™ or Milo.com electronic market places.

In some embodiments, the advertisement 170 includes information related to preferred purchasing opportunities that are available to buyers 180 when using the information contained in the advertisement 170 to access the listing on the computer network 110. As examples, user 140 may (i) offer the ability to purchase the items via the computer network 110 before the actual start of the garage sale 180; and/or (ii) provide a purchasing incentive (e.g., a discount) for people that use the computer network 110 to purchase any of the items that are part of the garage sale 180.

Referring now also to FIG. 4, which is a block diagram that shows an example system 400 for displaying on-line marketplace listings of items in a garage sale 180. The system 400 includes a communication module 402 coupled to a multiple listing engine 120.

The system 400 may further include sale items 404, images 408, and a database 410. The communication module 402 is configured to receive a request from a user 140 to list one or more sale items 404 on the computer network 110 that are part the garage sale 180. In an example embodiment, the communication module 402 is configured to receive via the network 110 from the user 140 a listing of one or more items for sale 404 that are part of a garage sale, and present via the network 110 at least part of the item listing to one or more buyers 160 connected to the network 110. The term “presenting” may include sending, allowing access to, or displaying to a user 140 or a buyer 160 at least a portion of the item listing. The listing may include only one item for sale. The listing may include information about the one or more items included in the listing. The term “presenting” may also include publishing or otherwise making available such content to the general public via the network 110, such as the internet for example.

In an example embodiment, the creation or viewing of an item listing may be performed by a user 140 or buyer 160 using the GUI on a respective electronic device 130. A request to search the item listing, view search results or a specific item for sale, or place an item listing on the electronic marketplace 150, may also be performed using an electronic device 130. Item listings for temporary seller locations such as garage sales located within a defined geographic region or at a defined location, such as a specific address, or a region defined by a ZIP code, or a region proximate the user 140 or buyer 160 (for example within a defined radius), may be created, identified, viewed or searched by a user 140 or buyer 160. These actions may be performed by the user 140 or buyer 160 using a respective electronic device 130. In some embodiments, the region may be defined by the automatic selection of a region by a module within the system 400 in response to a received request, or by the user 140 or a buyer 160. The user/buyer actions may be performed using a software application installed on the electronic device 130.

The multiple listing engine 120 may include various components that facilitate listing the sale items 404 on the electronic marketplace 150. The item listing placed in the electronic marketplace 150, such as eBay, craigslist.com, RedLaser™ or Milo.com for example. The placed listing may include a full listing of garage sale items 404 or only a partial listing of items remaining unsold at the garage sale. It will be appreciated that other listing compositions and permutations are possible. As an example, the multiple listing engine 120 may include a media receiving module 122, a processing module 124 and a data receiving module 126. The data receiving module 126 may be configured to receive data from the user 140, a buyer 160, or the database 410. The database 410 may include data that is associated with the sale items 404 and/or the garage sale 180 (e.g., location and hours of operation).

Items offered for sale at a temporary seller location can be included in mainstream on-line or retail commercial offerings and enjoy parallel publicity. Sellers can benefit from this additional exposure to potential buyers. Equally, prospective buyers searching the web for a desired item to purchase have greater depth of content to review. As described herein, buyers can in some embodiments identify specific items to purchase locally or within a defined geographic region, or at a location, of interest. Local buyers are put in touch with local sellers, and vice versa, and the scope of potential commerce is supplemented by items offered for sale at temporary seller locations, or offered in the “informal” market sector, as it were. In some embodiments, the processing module 124 may be configured to list the sale items 404 for sale. In addition, the database 410 may be a single database, or a combination of databases that are configured as a structured collection of records or data. The relevant data may be stored in the electronic device 130 and/or another electronic device that is connected the computer network 110 (e.g., an electronic device that forms parts of the electronic marketplace 150). In some embodiments, a listing of items for sale is received from a user 140 and includes an item identification element including one or more of a product descriptor, an image, a bar code, or a decoded bar code. The item identification element may include an element sourced from a website or an element sourced by the user 140 via a photo or bar code imaging application (e.g. RedLaser™) on an electronic device 130, for example.

The communication module 402 is able to receive requests from buyers via the computer network 110 to identify, search or review the listing. The item listing may include one or more of the garage sale items listed on the electronic marketplace (such as eBay or Milo.com, for example) as mentioned above. A search or other request may include an item identification element including one or more of a product descriptor, an image, a bar code, or a decoded bar code, for example. The item identification element may include an element sourced from a website or an element sourced by a buyer 160 via a photo or bar code imaging application (e.g. RedLaser™) on an electronic device 130, for example. The processing module 124 may search the item listing using the received item identification element. In response to a received request, the relevant information can be obtained from the database 410 once the buyer 160 accesses the multiple listing engine 120 through the communication module 402 using the information in the advertisement 170, or as included in an item identification element.

In some embodiments, the communication module 402 is configured to receive a request via the network 110 from a buyer 160 to purchase at least one of the items that are part of the garage sale. The communication module can in some embodiments send the purchase request to the user 140. In some examples, the purchase request may be received before the garage sale has begun, and in response to such a request, the communication module 402 may send or display a pricing discount to a buyer 160 submitting the purchase request, or a request to search the item listing, before the garage sale has begun. Pricing discounts may be offered to buyers 160 that come through a particular advertising source (e.g. an on-line advertisement), or that use a QR code or an image in their search request. Other discounts may be offered to buyers that are located in a particular area, for example, or that have a particular business relationship with the seller 140.

Working in conjunction with the processing module 124 for example, the communication module 402 can in some embodiments allow a buyer 160 to purchase at least one of the items that are part of the garage sale using an internet based payment action element, such as PayPal™ for example.

As discussed above, the database 410 (or databases) may store information related to purchasing preferences for buyers 160 that view the listing using the information provided in the advertisement 170. In some embodiments, the information related to purchasing preferences for buyers 160 that view the listing using the information provided in the advertisement 170 may be obtained from another database (not shown in the accompanying figures) that can be accessed via the computer network 110.

In some embodiments, the media receiving module 122 may be configured to receive the images 408 over the computer network 110 that are associated with the sale items 404. The user 140 may supply the images 408 via the electronic device 130. Depending on the type of data that is provided by the user 140 for the sale items 404, the sale items 404 may be extracted from images 408 that are received by the media receiving module 122 and/or the data that is received by the data receiving module 126.

The data in the database 410 may be utilized in creating the listing of the items 404 by the multiple listing engine 120, or in response to a query by a buyer 160 for items on marketplace 150 that are part of the garage sale 180. In addition, the database 410 may store the images 408 as well as any other data that is associated with the sale items 404.

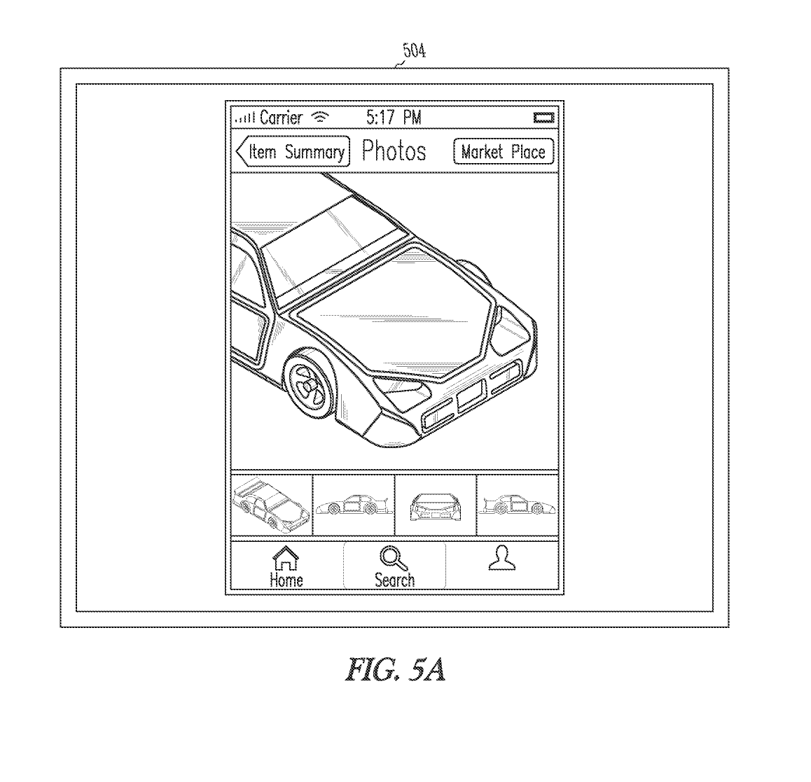

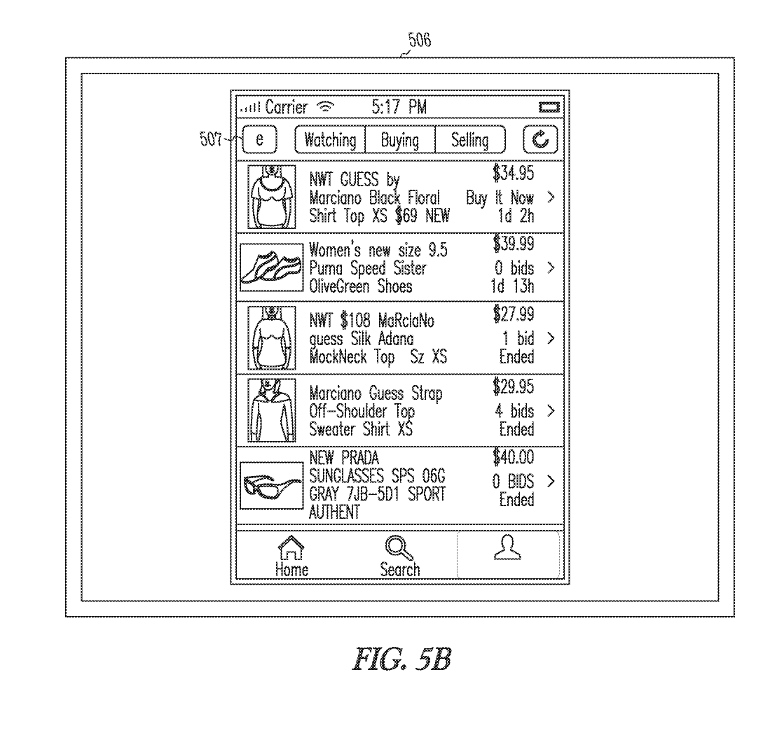

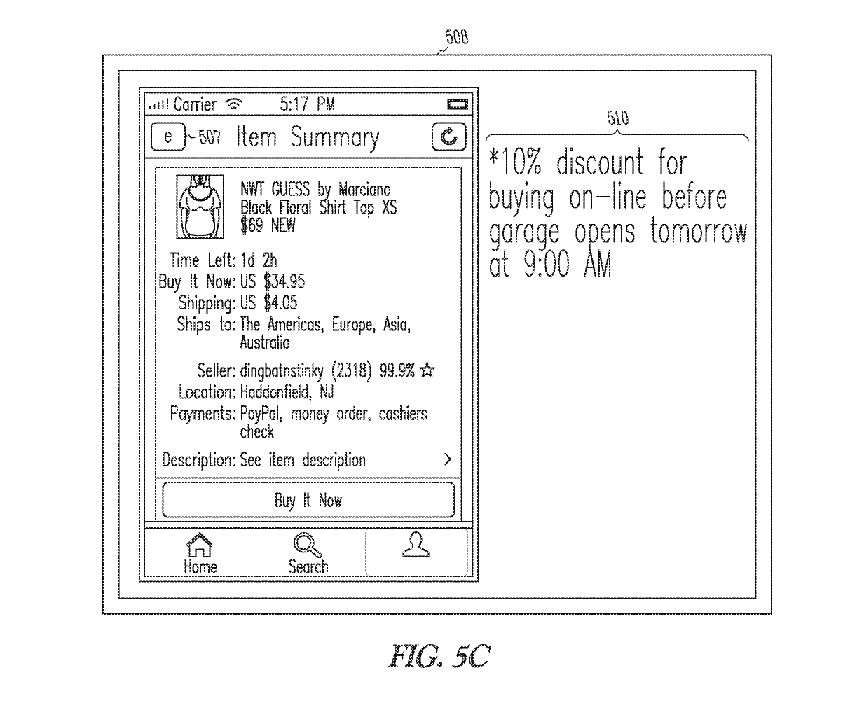

FIGS. 5A-5C illustrate some example screenshots showing marketplace listings displayed on the electronic device 130. The illustrated screenshots include photos 504 (FIG. 5A), multiple listings 506 (FIG. 5B), and an item summary 508 (FIG. 5C). It should be noted that any of the photos 504, multiple listings 506, and item summary 508 may reference the garage sale 180 and/or any preferred purchasing opportunities. The screenshots may include a logo 507 (such as eBay or Milo.com) of an electronic marketplace on which the garage sale items are listed. In the illustrated example embodiment, the item summary 508 displays information 510 that references the garage sale 180 and preferred purchasing opportunities.

The photos 504 show images 408 that may be supplied to the marketplace 150 by the user 140. The multiple listings 506 shows sale items 404 that may have been extracted from the database 410 based on a query received from a potential buyer 160. The sale items 404 in the listings 506 may be extracted from the database 410 along with the relevant images 408. The item summary 508 shows the summary of one item shown in the multiple listings 506.

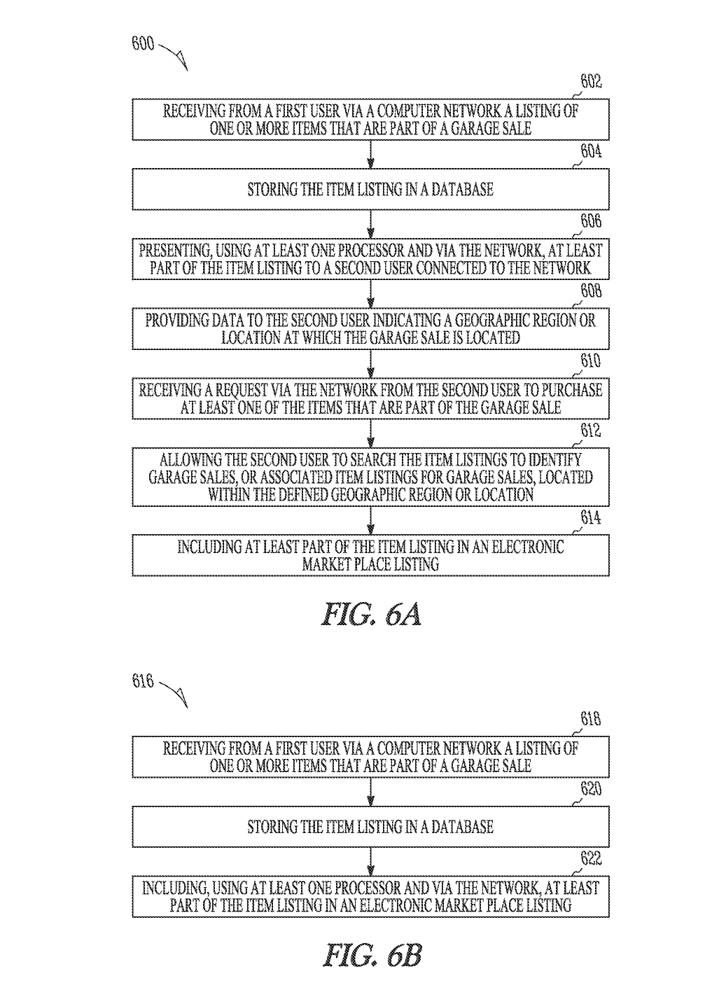

FIGS. 6A-6B illustrate example methods for on-line listings of items in a garage sale 180. Some portions of the methods may be performed by processing logic that may comprise hardware (e.g., dedicated logic, programmable logic, microcode, etc.), software (such as that which may be run on a general-purpose computer system or a dedicated machine), or a combination of both.

In one example embodiment, the processing logic resides at the multiple listing engine 120, illustrated in FIG. 4. Some portions of the methods may be performed by the various example modules discussed above with reference to FIG. 4. Each of these modules may comprise processing logic.

As shown in FIG. 6A, a method 600 commences at operation 602, with the communication module 402 receiving from a first user 140 via a computer network 110 a listing of one or more items 404 that are part of a garage sale. The method 600 further includes at operation 604, storing the item listing in a database 410. The method 600 includes operation 606 with the communication module 402 presenting, using at least one processor and via the network 110, at least part of the item listing to a second user (e.g. a buyer 160) connected to the network 110. The method 600 also includes at operation 608 providing data to the second user indicating a geographic region or location at which the garage sale is located.

In some embodiments, the operation 602 of receiving the item listing from the first user 140 includes receiving the item listing from the first user 140 via a first portable electronic device 130. In addition, the method 600 may include allowing at least one of the users 140 or 160 to create the item listing, or to view the item listing, using a software application installed on the first portable electronic device 130, or installed on a portable electronic device 130 operated by the one or more second users 160.

The method 600 may further comprise receiving a request via the network 110 from the second user 160 to search the item listing. The operation of receiving a request from the second user 160 to search the listing of items 404 may include receiving an item identification element from the second user 160, the item identification unit including one or more of a product descriptor, an image, a bar code, or a decoded bar code; using the item identification element to search the item listing in the database 410; and providing the search results to the user 160 submitting the request.

Other embodiments are contemplated where the operation 602 includes (i) receiving from the first user 140 an item identification element, the item identification element including one or more of a product descriptor, an image, a bar code, or a decoded bar code; and (ii) including in the item listing an item identified by the identification element.

In some embodiments, the method 600 further includes operation 610 where the communication module 402 and/or the processing module 124 receive a request via the network 110 from the second user 160 to purchase at least one of the items 404 that are part of the garage sale. The method 600 may further comprise sending the purchase request to the first user 140. The operation 610 of receiving the purchase request via the network 110 may include receiving the purchase request before the garage sale has begun. Still further, the method 600 may comprise sending or displaying a pricing discount to the second user 160. The method 600 may further comprise allowing the second user to purchase at least one of the items that are part of the garage sale using an internet-based payment action element.

The geographic region or location may be defined by the first or second user. The operation 604 of storing the item listing in a database may further comprise storing item listings for a plurality of garage sales located within the defined geographic region or location. In some embodiments, the method 600 further comprises at operation 612 allowing the second user 160 to search the item listings to identify garage sales, or associated item listings for garage sales, located within the defined geographic region or location. The method 600 may further comprise presenting to the second user a listing of the plurality of garage sales, or associated item listings for the plurality of garage sales, located within the defined geographic region or location.

The method 600 may in example embodiments include at operation 614 including at least part of the item listing in an electronic market place listing. At least part of the item listing included in the electronic marketplace listing may include a listing of items remaining unsold at a conclusion of the garage sale. The method 600 may further include receiving a request to search for at least one of the items included in the item listing, and providing the search results to the first or second users.

As shown in FIG. 6B, a method 616 commences at operation 618 with the communication module 402 receiving from a first user 140 via a computer network 110 a listing of one or more items 404 that are part of a garage sale. The method 600 further includes at operation 620, storing the item listing in a database 410. The method 600 includes operation 622 with one of the modules 122, 124, 126 or 402 including, using at least one processor and via the network, at least part of the item listing in an electronic market place listing.

The method 616 may further include at operation 624 presenting, using at least one processor and via the network, at least part of the item listing to a second user connected to the network. At least part of the item listing may include a listing of items remaining unsold at a conclusion of the garage sale.

In further aspects of methods 600 and 616, the media receiving module 122 and the data receiving module 126 of the multiple listing engine 120 receive images 408 and/or data from the user 140 relating to the one or more sale items 404 that are part of the garage sale 180. The processing module 124 can list the one or more sale items 404 on the computer network 110 such that images 408 and data associated with the one or sale items 404 is displayed as part of the listing. The pertinent data can be supplied by the user 140 to the communication module 402 using any type of electronic device 130. Some example electronic devices 130 include a desktop computer, laptop computer, mobile device (e.g., cell phone, PDA, global positioning system) or any other electronic device that is capable of interacting with the computer network 110 to provide data and/or images. In some embodiments, the multiple listing engine 120 retrieves the appropriate data and displays the listing along with the rest of information that pertains to the listing (e.g., image, description, any preferred purchasing opportunities, and/or any other information relevant to the garage sale 180).

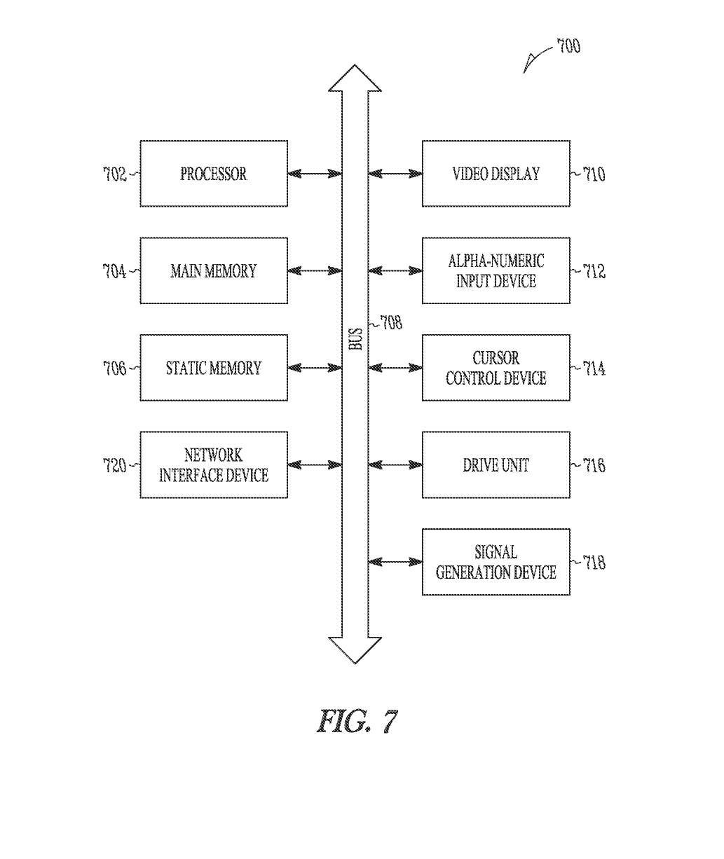

FIG. 7 illustrates an example computer system 700 that may be used as part of the systems and methods described herein. The example computer system 700 includes a processor or multiple processors 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 may also include an alphanumeric input device 712 (e.g., a keyboard), a cursor control device 714 (e.g., a mouse), a disk drive unit 716, a signal generation device 718 (e.g., a speaker) and a network interface device 720.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Thus, systems and methods for on-line marketplace listings of items in a garage sale have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A method comprising:
receiving from a first user, via a network, a listing of one or more items that are part of a garage sale;
storing the item listing in a database;
presenting, using at least one processor and via the network, at least part of the item listing to a second user connected to the network, and
providing data to the second user indicating a geographic region or location at which the garage sale is located.

2. The method of claim 1, wherein the receiving of the item listing from the first user includes receiving the item listing from the first user via a first portable electronic device.

3. The method of claim 2, further comprising allowing at least one of the users to create the item listing, or to view the item listing, using a software application installed on the first portable electronic device, or installed on a portable electronic device operated by the one or more second users.

4. The method of claim 1, further comprising receiving a request via the network from the second user to search the item listing, and presenting at least part of the item listing to the second user in response to the request.

5. The method of claim 4, wherein receiving a request from the one or more second users to search the item listing includes:
receiving an item identification element from the second user, the item identification unit including one or more of a product descriptor, an image, a bar code, or a decoded bar code;
using the item identification element to search the item listing in the database; and
providing the search results to the user submitting the request.

6. The method of claim 1, wherein the receiving of the item listing from the first user includes:
receiving from the first user an item identification element, the item identification element including one or more of a product descriptor, an image, a bar code, or a decoded bar code; and
including in the item listing an item identified by the identification element.

7. The method of claim 1, further comprising receiving a request via the network from the one or more second users to purchase at least one of the items that are part of the garage sale.

8. The method of claim 7, further comprising sending the purchase request to the first user.

9. The method of claim 7, wherein receiving the purchase request via the network includes receiving the purchase request before the garage sale has begun.

10. The method of claim 7, further comprising sending or displaying a pricing discount to the second user.

11. The method of claim 7, further comprising allowing the second user to purchase at least one of the items that are part of the garage sale listing using an internet-based payment action element.

12. The method of claim 1, wherein the geographic region or location is defined by the first or second user, and wherein storing the item listing in a database further comprises storing item listings for a plurality of garage sales located within the defined geographic region or location.

13. The method of claim 12, further comprising allowing the second user to search the item listings to identify garage sales, or associated item listings for garage sales, located within the defined geographic region or location.

14. The method of claim 12, further comprising presenting to the second user a listing of the plurality of garage sales, or associated item listings for the plurality of garage sales, located within the defined geographic region.

15. The method of claim 1, further comprising including at least part of the item listing in an electronic market place listing.

16. The method of claim 15, wherein at least part of the item listing includes a listing of items remaining unsold at a conclusion of the garage sale.

17. A method comprising:
receiving from a first user, via a network, a listing of one or more items that are part of a garage sale;
storing the item listing in a database; and
including, using at least one processor and via the network, at least part of the item listing in an electronic market place listing.

18. The method of claim 17, further comprising presenting, using at least one processor and via the network, at least part of the item listing to a second user connected to the network.

19. The method of claim 17, wherein at least part of the item listing includes a listing of items remaining unsold at a conclusion of the garage sale.

20. A system comprising:
at least one module, executing on one or more computer processors, to:
receive from a first user, via a network, a listing of one or more items that are part of a garage sale;
store the item listing in a database;
present, via the network, at least part of the item listing to a second user connected to the network; and
provide data to the second user indicating a geographic region or location at which the garage sale is located.

21. A machine readable medium, including instructions, which when performed by a machine, causes the machine to perform the operations of:
receiving from a first user, via a network, a listing of one or more items that are part of a garage sale;
storing the item listing in a database;
presenting, using at least one processor and via the network, at least part of the item listing to one or more second users connected to the network; and
providing data to the second user indicating a geographic region or location at which the garage sale is located.

22. A system comprising:
at least one module, executing on one or more computer processors, to:
receive from a first user, via a network, a listing of one or more items that are part of a garage sale;
store the item listing in a database; and
include, via the network, at least part of the item listing in an electronic market place listing.

23. A machine readable medium, including instructions, which when performed by a machine, causes the machine to perform the operations of:
receiving from a first user, via a network, a listing of one or more items that are part of a garage sale;
storing the item listing in a database; and
including, using at least one processor and via the network, at least part of the item listing in an electronic market place listing.
